(19) United States
(12) Patent Application Publication
(10) Pub. No.: US 2013/0132126 A1
(43) Pub. Date: May 23, 2013

(54) FINANCIAL INSURANCE PRODUCT FOR HYDROCARBON RESERVES

(71) Applicants: Per A. Sekse, Darien, CT (US); Robert J. Forness, Chatham, NJ (US)

(72) Inventors: Per A. Sekse, Darien, CT (US); Robert J. Forness, Chatham, NJ (US)

(21) Appl. No.: 13/741,983

(22) Filed: Jan. 15, 2013

Related U.S. Application Data
(63) Continuation of application No. PCT/US2011/043830, filed on Jul. 13, 2011.
(60) Provisional application No. 61/399,632, filed on Jul. 15, 2010.

(51) Int. Cl. G06Q 40/08

(52) U.S. Cl. CPC G06Q 40/08
USPC 705/4

(57) ABSTRACT

A method and system for calculating and insuring the residual value of hydrocarbon reserves (such as oil, natural gas, and gas liquids) as of a specified date or series of dates for a specific oil and natural gas well, field, or combination of fields and/or petroleum properties. Geological data, production data and other types of engineering data are combined with financial data, capital expenditure data and commodity price data as inputs into an insurance transaction analysis and pricing system resulting in the generation of an expected loss profile and insurance premium for providing the insured with a minimum residual value for the covered reserves.

### CROSS-REFERENCE TO RELATED APPLICATIONS

This Application is a continuation of International Application No. PCT/US2011/043830 filed on Jul. 13, 2011 which in turn claims the benefit of U.S. Provisional Application 61/399,632 filed on Jul. 15, 2010. Each of the aforementioned applications is incorporated by reference herein in its entirety.

### BACKGROUND OF THE INVENTION

1. Field of the Invention

The present invention relates to systems and methods for the valuation of oil, natural gas, and gas liquid reserves used as collateral for financing that can be in the form of bank loans, pre-paid production payments, capital market debt transactions (public and private placements) or other combinations of debt and equity instruments. In particular, the present invention relates to systems and methods for producing an expected loss table and the corresponding premium for use in residual value insurance used in connection with borrowing base calculations made by financial institutions to determine the size of a revolving credit facility collateralized by hydrocarbon reserves.

2. Background of the Related Art

Companies in the business of finding, developing and producing oil, natural gas, and gas liquids (generally referred to as E (exploration) and P (production) companies or an E&P company), have a need to make significant capital expenditures to turn proved reserves into producing reserves that can be sold in the commodity markets, converting oil and gas in the ground into physical product that can be used above ground. The source of funding for these capital expenditures varies depending on the size of the E&P company, its access to debt and equity markets, and ultimately the value of the proved reserves it can offer as collateral. Because the future value of any given oil, natural gas or gas liquids reserve is uncertain, its estimated collateral value is a critical factor in determining the borrowing base for lending purposes. Conservative or low collateral value estimates by financial institutions can limit the amount of funding available to E&P companies seeking capital to develop these reserves, impacting their long term profitability and return on equity for shareholders. The E&P company can typically secure additional financing through the secondary market, but such financing may be more expensive and thus less desirable.

There are three general types of reserve classifications: (1) Proved, (2) Probable, and (3) Possible. Within the Proved classification, there is a further breakdown into three types of Proved reserves. These are:

Proved Developed Producing—PDPs

Proved Developed Not Producing—PDNPs

Proved Undeveloped—PUDs

The first classification of reserves, Proved, carries the majority of weight in determining the collateral value of reserves. However, by investing capital in drilling new wells an E&P company can turn PUDs into PDPs that increases the collateral value of reserves for future borrowing base calculations. As long as the decline in PDPs due to ongoing production is less than the increase in PDPs resulting from the development of PUDs, the borrowing base increases and the E&P company has access to more and more capital for future capital expenditures, a growth spiral. The risk for the lending financial institution is that the borrowing base does not increase as a result of these capital expenditures and the collateral value declines below a minimum required level. This triggers a reduction in the credit facility and forces the E&P company to use cash flow to repay debt instead of for developing PUDs. As PDPs continue to produce, their value declines if not replaced by new reserves over time, a death spiral. It would be advantageous for both the E&P company and its lender to avoid the death spiral scenario through some form of assurance that the value of the collateral does not fall below a minimum level.

Therefore, there is a need for a method of insuring the value of these reserves at specific points in time when the borrowing base is re-determined by the lender. More specifically, there is a need for systems and methods for the valuation of oil, natural gas, and gas liquid reserves used as collateral for financing. Still further, there is a need for systems and methods for producing an expected loss table and the corresponding premium for use in residual value insurance used in connection with borrowing base calculations made by financial institutions to determine the size of a revolving credit facility collateralized by hydrocarbon reserves.

### BRIEF DESCRIPTION OF THE DRAWINGS

So that those having ordinary skill in the art to which the present invention pertains will more readily understand how to employ the systems and methods of the present invention, embodiments thereof will be described in detail herein below with reference to the drawings, wherein:

FIG. 1 (1A and 1B) is a flow chart depicting the data which is provided by the E&P company and used to determine the first input for the residual value insurance pricing model;

FIG. 2 is a flow chart depicting the data which is used to generate the second input for the residual value insurance pricing model;

FIG. 3 (3A and 3B) is a flow chart depicting how the first and second inputs to the pricing model are used to determine the third input to the pricing model; and

FIG. 4 (4A and 4B) is a flow chart depicting how the first, second and third inputs to the pricing model are combined with the fourth (company credit spread) and fifth (potential loss recoveries) inputs to determine a probability of loss, a loss recovery expectation, a dollar value for all reserves, and a cash flow waterfall which are used to determine an insurable amount and premium.

These and other aspects of the subject invention will become more readily apparent to those having ordinary skill in the art from the following detailed description of the invention taken in conjunction with the drawings.

### DETAILED DESCRIPTION OF PREFERRED EMBODIMENTS

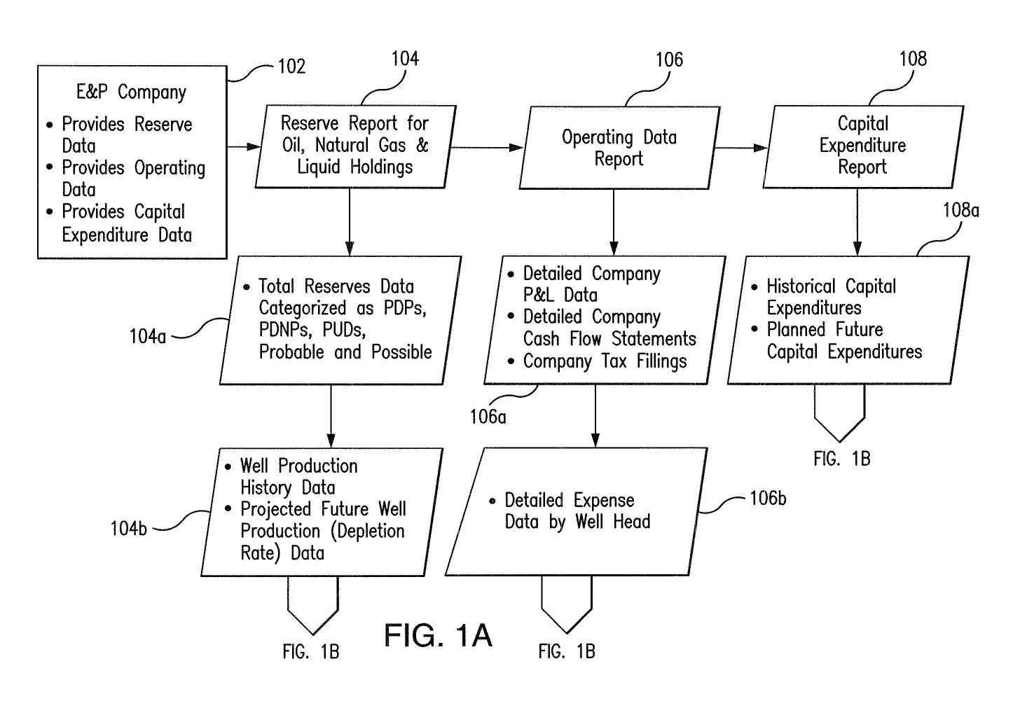

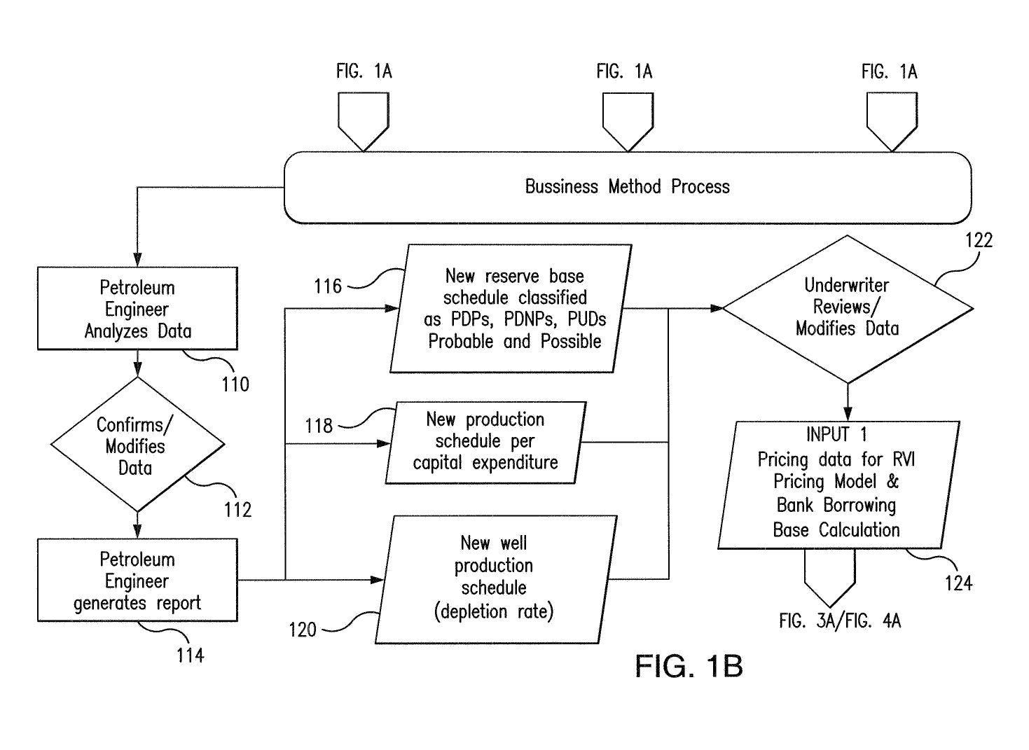

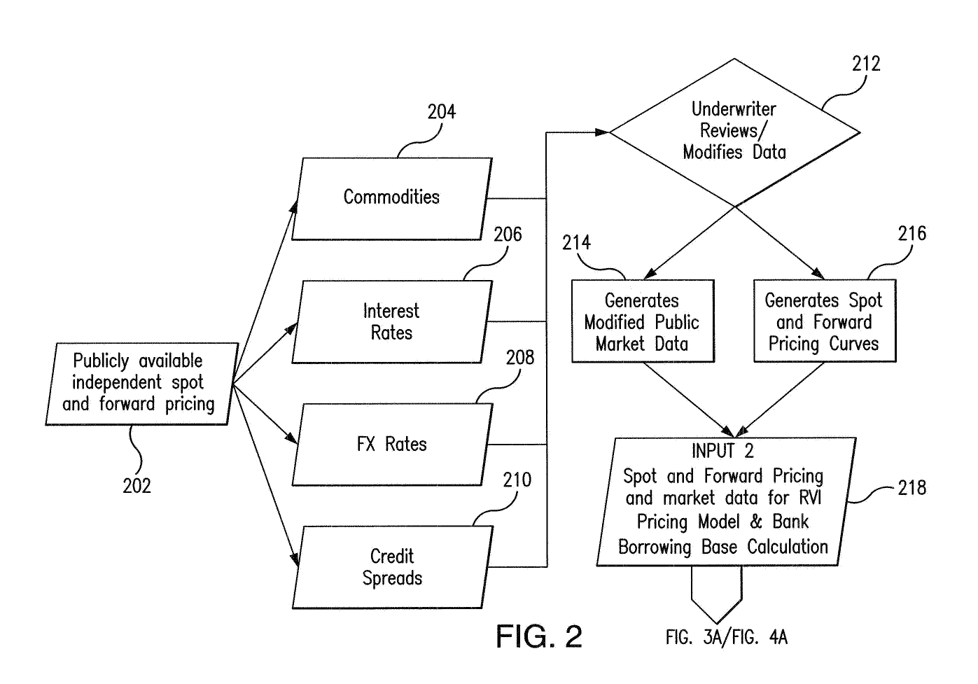

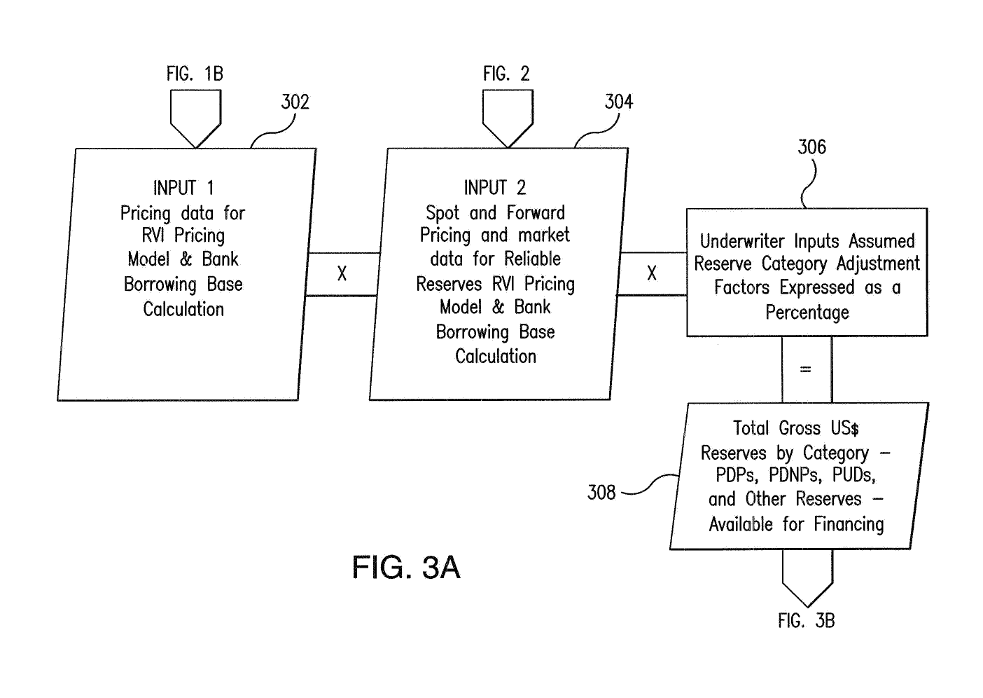

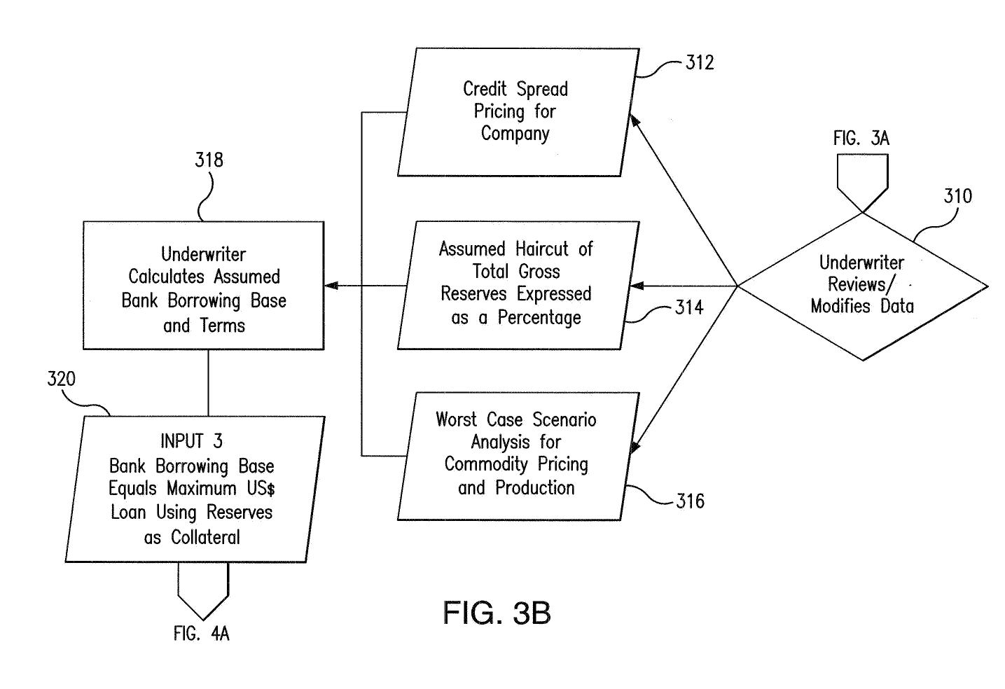

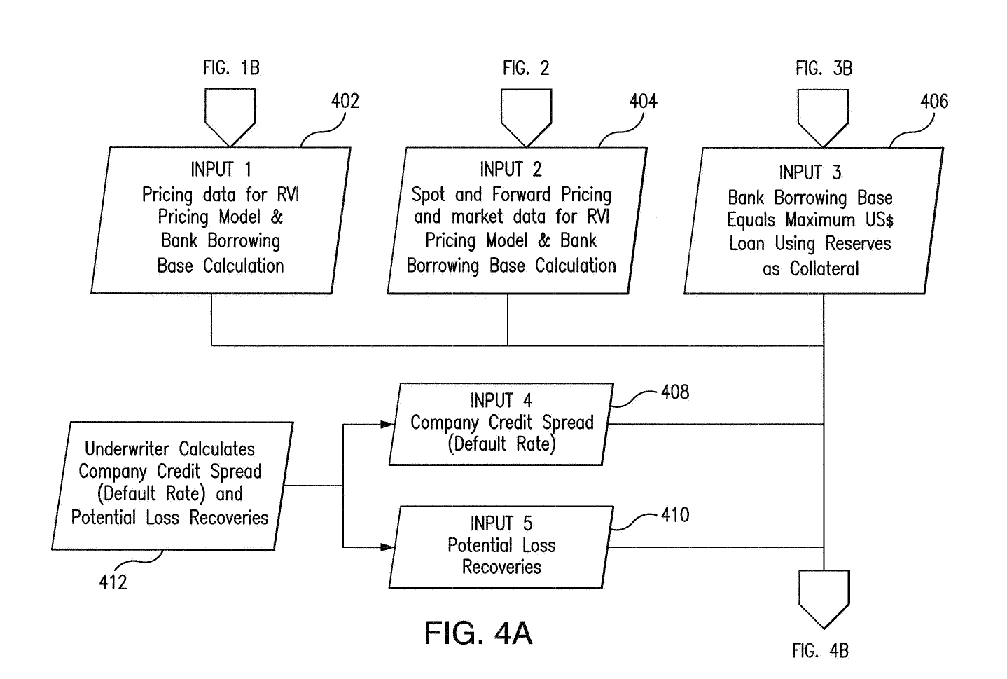

Embodiments of the present invention are now described with reference to the drawings. FIGS. 1-4 provide block diagrams/flow charts detailing the process steps for the pricing model or insurance premium calculation system according to the first embodiment of the present invention.

Before discussing the specific embodiment illustrated in FIGS. 1-4, exemplary hardware architecture for implementing embodiments of the present invention will now be described. Specifically, one embodiment of the present invention can include a computer communicatively coupled to a network. The Internet is an example of a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc.), or the like. In embodiments of the invention, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium such as a hard drive. Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of complied C++, Java, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

As noted above, the present invention is directed to systems and methods for producing an expected loss table and the corresponding premium for use in residual value insurance used in connection with borrowing base calculations made by financial institutions to determine the size of a revolving credit facility collateralized by hydrocarbon reserves.

Residual Value Insurance (RVI) is used to guarantee the value of an asset at a specific date in the future. It is frequently applied to transactions involving automobile fleets, aircraft, ships and real estate, and other assets which are usable over long periods of time. Generally speaking, an owner of an asset expects to benefit from the use of that asset over time and expects the asset value to depreciate in accordance with a depreciation schedule (or appreciate in value as in the case of some real estate) while retaining an estimated residual value at the end of a specified period of time (e.g., a 3 year car lease). Moreover, in the case where a loan collateralized by the asset is used to finance improvements to and/or the development of the asset, the future value of the asset as collateral for the loan takes on more prominence. In particular, if a borrower wants a loan that does not fully amortize during its term, the lender is at risk that the final payment (balloon) will not be fully collateralized by the value of the asset on the balloon payment date.

In such a case, the lender may require that RVI be secured by the borrower to ensure that the asset will be of sufficient value to collateralize the balloon payment. Simply stated, in the event that a borrower fails to make the balloon payment, the lender is forced to seize the collateral (e.g. through foreclosure proceedings) and sell it in the open market to recover the amount due. An RVI policy will pay a claim by the lender for any realized shortfall between the sale price of the asset applied toward the balloon payment and the residual value of the asset ensured by the RVI policy. In the event asset sale proceeds are sufficient to cover the balloon payment, no loss is incurred and a RVI claim is not applicable. Prior to the lender seizing the collateral the insurer may take steps to enhance the value of the asset so it can be sold for the best possible price. Under some circumstances the insurer can also seek recovery from the borrower if the RVI policy is used to pay the lender in full and the insurer chooses to takes control of the collateral just the same as the lender could have.

The present invention solves the death spiral problem by providing a method and system for offering residual value insurance against the risk reserves might fall below a minimum level on any specified date used for re-determining the borrowing base.

As will be described below, in one embodiment of the present invention, an important feature is the ability to use the input of geological data, production data, other types of engineering data, financial data, capital expenditure data and commodity price data in an insurance transaction analysis and pricing system that produces an expected loss table and corresponding premium for residual value insurance. Rather than use simple deterministic (worst case base case) scenario analysis, the present invention uses actuarial based probable outcomes combined with loss mitigation and recovery to more precisely determine the value of the reserves and offer a beneficial cost effective risk management solution.

In some embodiments of the present invention, the residual value insurance is used to support the accounting value of reserves reported in an E&P companies financial statements.

Reference is now made in detail to the exemplary embodiments, examples of which are illustrated in the accompanying drawings. Referring now to FIGS. 1A and 1B, which in combination provide a flow chart depicting the manner in which data provided by the E&P company is used to determine a first input for the residual value insurance pricing model. In block 102, the E&P company which owns and operates a particular hydrocarbon field for which residual value insurance is sought, provides reserve data 104, operating data 106 and capital expenditure data 108. It should be noted that in many, if not all instances, the reserve data 104, operating data 106 and capital expenditure data 108 can be obtained from publicly-available information, such as financial statements, and therefore input from the E&P company may not be required.

The reserve data 104 can contain a reserve report for all of the oil, natural gas and liquid holdings within the reserve field. The data contained in the reserve report provides a detailed breakdown on a well-by-well basis that includes, among other information, the production history for each well (block 104b) and an estimate of how much oil, gas, etc. is in the ground. In block 104a each well is categorized as proven, probable or possible and the proven wells are identified as a PDP, PDNP or a PUD.

The operating data report 106 provides information such as, a detailed company P&L report, company cash flow statements and tax filings (block 106a) and detailed expense date for each well head (block 106b).

The capital expenditure reporting 108 will include information such as the historical capital expenditures and planned future capital expenditures for the field (block 108a).

In certain constructions of the present invention, each of these reports is reviewed by a petroleum engineer at block 110 who analyzes the data, confirms or modifies the data based on experience (block 112). The petroleum engineer can generate a report 114 which includes: a new reserve base schedule 116 classified as PDPs, PDNPs, PUDs, probable and possible, a new production schedule per capital expenditure 118 and a new well production schedule (depletion rate) 120. As shown, in FIG. 1B, it is envisioned that all of this data can be reviewed and modified by an insurance underwriter at block 122 prior to it being input into the pricing model. Like the petroleum engineer, the underwriter can be a person with many years of experience in the field of underwriting and verify that the data being input into the pricing model is accurate and realistic (it makes sense). However, those skilled in the art will readily appreciate that the reserve data 104, operating data 106 and capital expenditure data 108 can feed directly into the pricing model without revision or it can be manipulated using actuarial or historical models as desired. As shown in step 124, the data is used as the first input to the RVI pricing model and bank borrowing base calculation.

Referring now to FIG. 2 which provides a flow chart depicting the data which is used to generate the second input for the RVI pricing model. As shown therein, the second input is developed using publicly available independent spot and forward pricing data for the hydrocarbon commodity (block 202). Commodities information, including the historical spot price and forward pricing information over the expected time horizon is provided at block 204. Also included are the current and projected interest rates 206, foreign exchange rates 208 and credit spreads 210. As before, block 212 illustrates that all of this data can be reviewed and/or modified by an insurance underwriter prior to being input into the pricing model. The underwriter can generate modified public market data 214 and spot and forward pricing curves 216. The public market data and spot and forward pricing data are used as the second input to the pricing model and bank borrowing base calculation at step 218.

Referring now to FIG. 3A wherein the pricing data which represents input 1 for the pricing model (block 302) is combined with the spot and forward data and market data which represent input 2 for the pricing model (block 304). An adjustment is made to the data at block 306 wherein the dollar values calculated for each well head are multiplied by a factor which takes into account historical experience, such as type of well and location within a particular geographical area. For example, all of the values for the PDP wells could be multiplied by a factor of 1.0 (100% or no adjustment) and the values for the PDNPs by a factor of 0.9 (90%). These adjustments could be present in the model or determined by an underwriter on a case-by-case basis. As a result, at block 308 a total gross US dollar value available for financing is calculated for the reserves by category. These numbers represent a measure of the current collateral base.

Again at step 310 an underwriter could optionally intercede and review and modify the dollar value assigned to the current collateral base. Next at step 312 the credit spread pricing for the E&P company is determined. A haircut, expressed as a percentage, can also be applied at step 314 to the total gross reserves. The model also performs a worst case scenario analysis for commodity pricing and production at step 316. From this information an Assumed Bank Borrowing Base and terms are calculated (block 318). This step can be performed by an underwriter or using known lending software. The result (block 320) represents input three to the pricing model (i.e., the Bank Borrowing Base or maximum US$ loan using reserves as collateral).

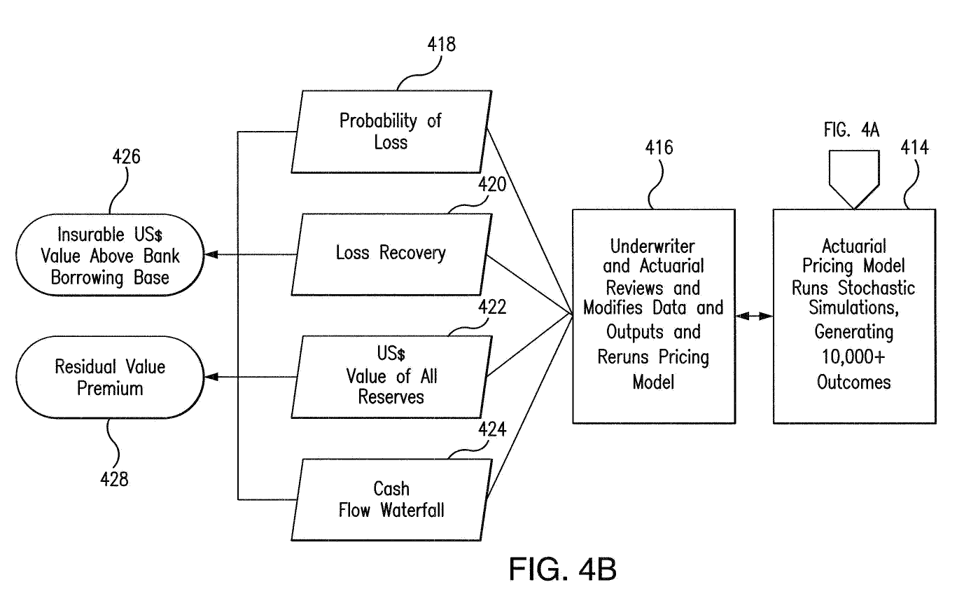

Referring now to FIG. 4 which provides a flow chart that depicting how the first (block 402), second (block 404) and third (block 406) inputs to the pricing model are combined with a company credit spread (fourth input—block 408) and a potential loss recoveries (fifth input—block 410). As indicated in block 412, an underwriter can provide the fourth and fifth inputs to the model. The fifth input or the potential loss recoveries relate to the quantity in dollars of the reserve that the issuer of the RVI policy would expect to receive upon sale of the asset (after foreclosure for example). In addition to determining the value of the asset, the loss recovery analysis accounts for the costs associated with the liquidation of the asset, such as legal fees. Moreover, the underwriter takes into account steps that could be taken to improve the value of the reserves prior to sale to reduce the insurer's loss and factors in the costs associated with any such improvements. For example, in certain circumstances, the policy issuer would have the right to bring in an independent third party to take over day to day operation of the reserve field and improve production output.

Each of the inputs is applied to an actuarial pricing model of the present invention which runs stochastic simulations and generates thousands of outcomes. (block 414) In the simulations, each of the data inputs is changed over time to determine various potential scenarios. In an embodiment of the present invention, an underwriter and/or and actuary reviews the output of the actuarial pricing model (block 416). If deemed necessary, the data and output of the model is modified and the pricing model is rerun. Based on these calculations, a probability of loss (block 418), a loss recovery expectation (block 420), a dollar value for all reserves (block 422), and a cash flow waterfall (block 424) (i.e., how the dollars coming into the E&P company will be used to pay down development financing) are determined. These results are used to determine an insurable amount above the bank borrowing base (block 426) and the insurance premium (block 428).

1. A computer-implemented method for determining the policy amount and premium for residual value insurance for hydrocarbon reserve assets pledged as collateral for various forms of capital expenditure financing, the method comprising the steps of:
a) receiving in a data storage device as a first input, pricing data, the pricing data including a reserve base schedule, a production schedule, a capital expenditure schedule and a new well production schedule;
b) receiving in a data storage device as a second input, spot and forward pricing and market data for the hydrocarbon;
c) determining, using a data processor, a total gross dollar value for the reserves within the hydrocarbon reserve asset based on the first and second inputs;
d) determining, using a data processor, a maximum bank financing amount for the reserves which is based at least on the total gross dollar value for the reserves within the hydrocarbon reserve asset and on a worst case scenario analysis for commodity pricing and well production;
e) storing in a data storage device as a third input the maximum bank financing amount for the reserves;
f) receiving in a data storage device as a fourth input, a credit spread for an operator of the hydrocarbon reserve assets;
g) receiving in a data storage device as a fifth input, a potential loss recoveries value; and
h) determining in a data processor and using an actuarial model, the policy amount and the premium for the residual value insurance based on the first, second, third, fourth and fifth inputs.
